(19) United States
(12) Patent Application Publication
(10) Pub. No.: US 2006/0171852 A1
(43) Pub. Date: Aug. 3, 2006

(54) Microfluidics prototyping platform and components

(75) Inventor: Ronald F. Renzi, Tracy, CA (US)

Correspondence Address: MICHALESON & ASSOCIATES, P.O. BOX 8489, RED BANK, NJ, 07701-8489, US

(73) Assignee: Sandia National Laboratories, Livermore, CA (US)

(21) Appl. No.: 11/049,378

(22) Filed: Feb. 2, 2005

(51) Int. Cl. B01L 3/00

(52) U.S. Cl. 422/100

(57) ABSTRACT

The present invention relates generally to components for the fabrication of microfluidic systems, particularly to components and combinations of components for the rapid and robust fabrication of prototype microfluidic systems, and to components allowing the positioning of microfluidic devices or components for subsequent encapsulation. A design for a prototyping platform, fittings, interconnects, and other components are described having structures such that flexible assembly into a virtually unlimited array of possible prototype systems is both feasible and efficient.

### STATEMENT REGARDING FEDERALLY SPONSORED RESEARCH OR DEVELOPMENT

This invention was made with Government support under government contract no. DE-AC04-94AL85000 awarded by the U.S. Department of Energy to Sandia Corporation. The Government has certain rights in the invention, including a paid-up license and the right, in limited circumstances, to require the owner of any patent issuing on this invention to license others on reasonable terms.

### BACKGROUND OF THE INVENTION

1. Field of Invention

This invention relates generally to the field of microfluidics and microfluidic devices and, more particularly, to microfluidic systems and components for flexible and rapid fabrication of microfluidic devices.

2. Description of the Prior Art

Microfluidics is a research and engineering discipline dealing with transport phenomena and fluid-based devices at microscopic length scales. Some authors state that microfluidic devices have the potential to effect a major change in instrumentation by producing cheap, disposable systems for the mass market. See, for example “Fundamentals and Applications of Microfluidics,” by N.-T Nguyen and S. T. Wereley, (Arttech House, 2002). Fields such as biotechnology, drug design, proteomics and other fields in life and chemical sciences show potential for major advances through applications of microfluidics.

However, several challenges arise in the construction of systems consisting of interconnected microfluidic devices and related components. Such devices typically function at the interface between meso-scale and micro-scale dimensions. That is, internal fluid pathways and the like typically approach micro-scales, while the dimensions of overall components, suitable for assembly by human technicians, are typically meso-scale. Fabrication of prototype devices at this dimensional interface must deal with inherently diverging considerations with the relatively fragile nature of micro-components and the relatively coarse nature (at such dimensions) of human mechanical manipulations.

Microfluidic fabrication challenges arise in the fabrication of prototype microfluidic systems from discrete microfluidic devices and related components, especially when designs are not fully determined and some flexibility and experimentation in fabrication is advantageous, or when prototype microfluidic system boards providing discrete component protection or application-specific functional needs exist.

Therefore, a need exists in the art for systems, devices and components for the rapid and robust fabrication of microfluidic devices and prototype microfluidic devices.

### SUMMARY OF THE INVENTION

Accordingly and advantageously the present invention relates to the fabrication of microfluidic systems in a rapid, robust and flexible manner, thereby facilitating microfluidic prototyping.

The invention further relates to a prototyping platform having a structure so as to facilitate the rapid and robust fabrication of microfluidic systems. Typical prototyping platforms pursuant to some embodiments of the present invention have an array of holes therein in a standard geometry and size suitable for receiving a variety of fasteners for attaching various microfluidic devices and other components. Several other components are also described, including interconnects, spacers, fasteners, fittings and capillaries having structures coordinate with the structure of the prototyping platform, further facilitating rapid and flexible assembly of microfluidic systems. Additionally, encapsulating components after they are mounted in desired locations on the prototyping platform allows for a single robust assembly that can serve any of a variety of functional purposes including, for example, serving as a heat dissipator, insulator, grounding plane, electrostatic discharge medium, baffle for light, acoustic or electromagnetic waves, or as a direct mounting platform, among other purposes.

These and other advantages are achieved in accordance with the present invention as described in detail below.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not to scale.

The techniques of the present invention can readily be understood by considering the following detailed description in conjunction with the accompanying drawings, in which:

FIG. 1 is a perspective view of one example of a prototype microfluidic system.

FIG. 2 is a magnified view of exemplary fittings for connecting and interconnecting microfluidic components.

FIG. 3 depicts a type of fitting found to be advantageous in connection with some embodiments of the present invention.

FIG. 4 depicts four types of microfluidic interconnects along with a US 25 cent coin for size comparison.

FIG. 5 depicts an elevated view (A) and a side view (B) of a typical “Tee” interconnect showing fitting ports and mounting features.

FIG. 6 depicts an elevated view (A) and a side view (B) of a typical “Elbow” interconnect showing fitting ports and mounting features.

FIG. 7 depicts an elevated view (A) and a side view (B) of a typical “Union” interconnect showing fitting ports and mounting features.

FIG. 8 depicts an elevated view (A) and a side view (B) of a typical “Cross” interconnect showing fitting ports and mounting features.

FIG. 9 is an elevated view of a typical prototyping platform pursuant to some embodiments of the present invention.

FIG. 10 is a perspective view of typical interconnects and spacers on a prototyping platform.

FIG. 11 is a side view of a typical microfluidic device bolt-mounted with spacers on a prototyping platform.

FIG. 12 is a perspective view of a typical microfluidic device, a syringe and syringe pump combination, strap mounted with spacers on a prototyping platform.

FIG. 13 is a schematic top view of the device combination of FIG. 12 configured for screw mounting.

FIG. 14 depicts a type of fitting found to be advantageous in connection with some embodiments of the present invention.

### DETAILED DESCRIPTION

After considering the following description, those skilled in the art will clearly realize that the teachings of the invention can be readily utilized in the fabrication of microfluidic devices.

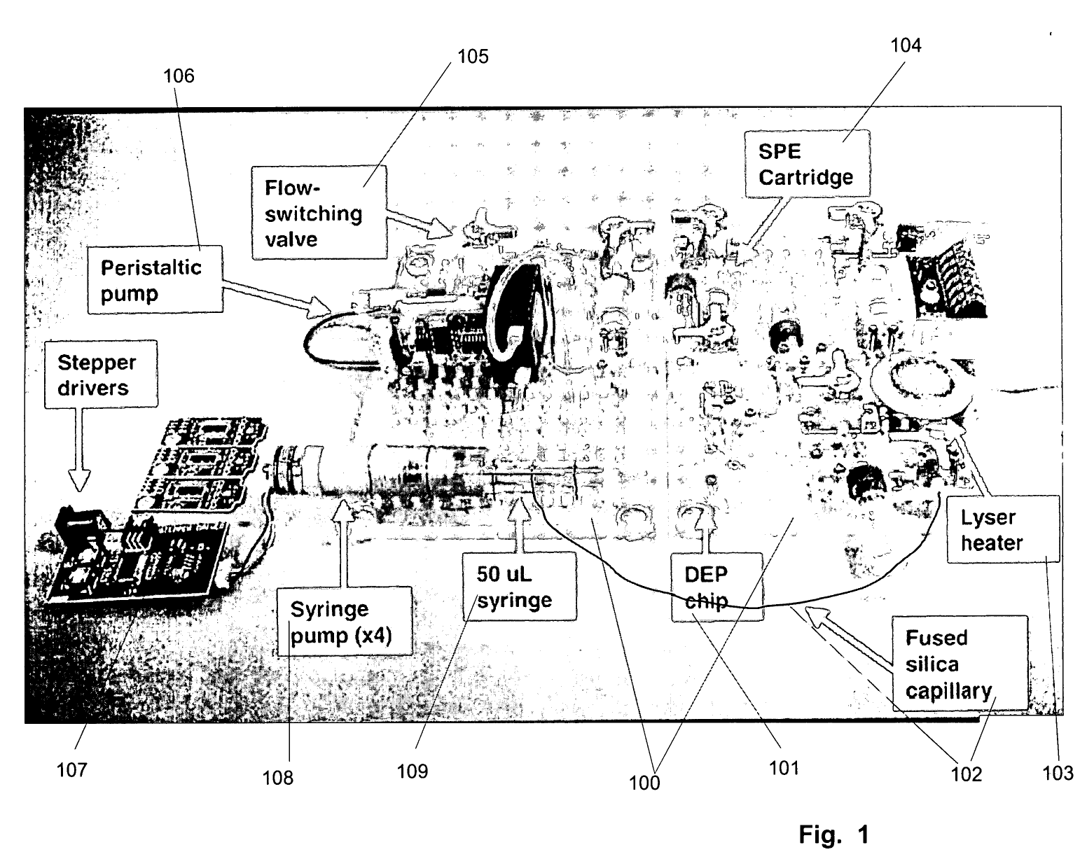

FIG. 1 depicts a typical example of a microfluidic system that potentially would be constructed making use of various components, devices and combinations pursuant to some embodiments of the present invention. The example of FIG. 1 includes two prototyping platforms 100 to which numerous components are or could be attached. Examples depicted in FIG. 1 include a syringe 109, its associated syringe pump 108 and the drivers for the stepper motors, 107. Other typical components depicted in FIG. 1 include a peristaltic pump 106, one or more valves 105, lyser heater 103, dielectrophoresis (DEP) concentration chip, solid phase extraction (SPE) cartridge, among other components. The working fluid of the device is delivered among components by fluid conduits, typically capillary tubes 102, and commonly fused silica capillaries as depicted in FIG. 1. However, other types of fluid conduits can also be employed in a microfluidic device such as that depicted in FIG. 1 as well as alternative or different types of capillaries or conduits. Various signal or current-carrying conduits such as wires and/or optical fibers can also be included as well as heat-conducting thermal paths. For economy of language, we refer to all such conduits as “paths” whether they carry fluid, heat, electrical current or signals in the form or light or other electromagnetic waves.

As apparent from the complexity of FIG. 1, the construction of microfluidic prototype devices can be an involved, arduous and manually difficult task in which it is desirable that standard components be employed that are capable of assembly in diverse configurations. Advantages of the present invention include the ability to assemble microfluidic components into numerous standard and non-standard configurations including, for example, in non-perpendicular configurations. That is, the major axes of interconnects and other components need not be restricted to have only parallel and perpendicular orientations with respect to the prototyping platform 100. Furthermore, stack mountings with components mounted immediately above one another, and variable-height mounting to accommodate various component dimensions, are also feasible in some embodiments of the present invention. Such stack mountings can include attaching overlying platforms or components to one another via fasteners that engage an amenable feature located on any surface of another platform or component. For example, two platforms, each with it's own components, can be kept apart a desired distance by spacers located between the two platforms, and held together by individual fasteners, each of which engages both platforms. Or components can attach directly to other components already attached to a platform, for example, a protruding fastener on one component can engage a mating feature on another component. Or both platform and component attachments can be used in dual or multi-level stacking.

It is envisioned that an important advantage of the present invention relates to the ability to construct prototype microfluidic systems rapidly and efficiently. However, the present invention is not limited to prototyping. The construction of any microfluidic system is likely to be facilitated by using components, devices and systems as described herein. Operational microfluidic devices can be fabricated as described herein and, if desired, may then be encapsulated in epoxy or another sealant. It is advantageous that the microfluidic materials, structures and components be selected, whenever feasible, to facilitate encapsulation and to be compatible with encapsulating materials. Candidate microfluidic materials include TEFLON, other fluorinated polymers, and/or other materials that do not adhere to epoxy or to other encapsulating material.

Such encapsulated microfluidic systems can be prepared in numerous embodiments including, but not limited to: Removal of the prototyping platform after encapsulation; Use of an encapsulating medium that is flexible even after curing (such as might be used to fit inside other instruments or housings; Use of an encapsulating medium that has desired thermal and/or electrical properties such as functioning as a heat sink, electrostatic dissipating medium, electrical conducting (or insulating medium as desired) The encapsulating medium can be quite thin (for example, only thick enough to retain all components), or thick enough to serve itself as the mounting platform (perhaps allowing for removal of the prototyping platform), or designed and constructed to provide any of a variety of application-specific functions. Encapsulation can also be performed so as to include channels within the encapsulating medium, further adding to the design flexibility of the microfluidic system. Such encapsulated devices are, or can be made, suitable for incorporation into practical instrumentation. However, to be concrete in our descriptions, we describe the typical case of the fabrication of prototype microfluidic devices, understanding thereby that this is illustrative and not limiting, and the present invention is not restricted to prototyping.

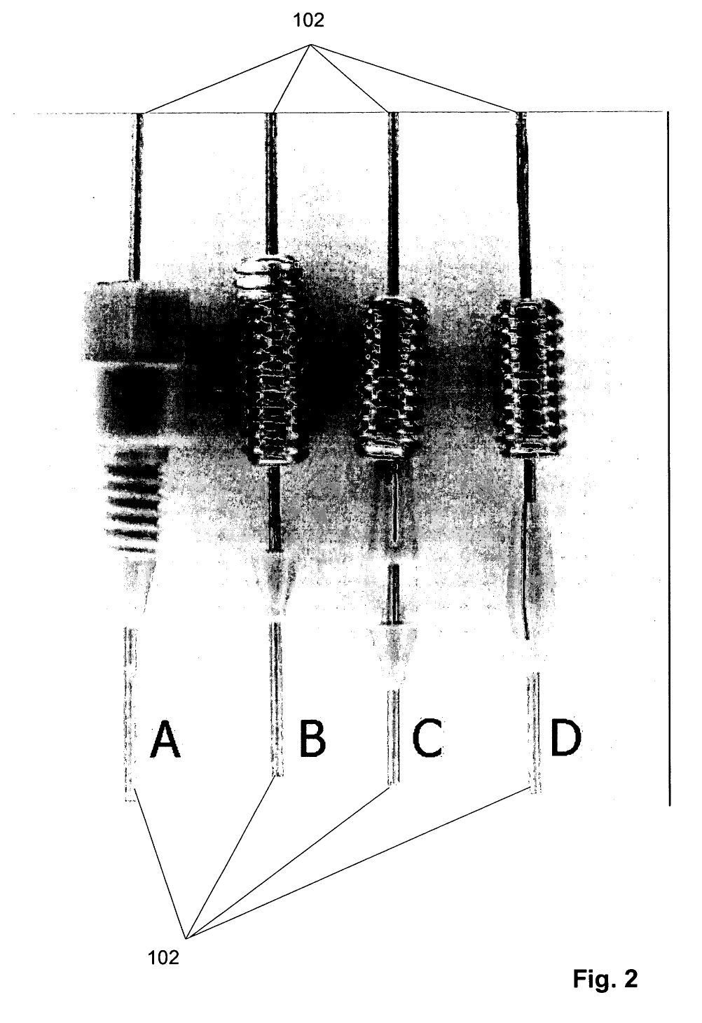

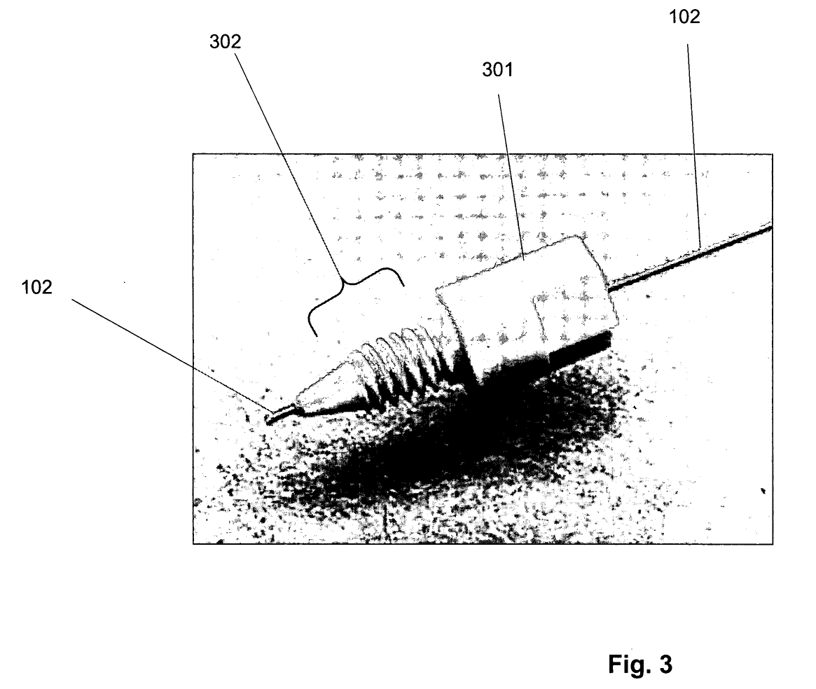

An important factor in the fabrication of microfluidic devices pursuant to some embodiments of the present invention relates to the fittings that are used to support, deliver and interconnect the fluid-carrying capillaries between various microfluidic components. Typical fittings are depicted in FIG. 2 including the capillaries, 102. The fitting of FIG. 2A is an advantageous design, depicted in more detail in FIG. 3. This fitting includes a threaded portion 302 for firmly sealing the tapered portion or ferrule into the various microfluidic components either by hand-tightening the fitting base 301, or by tightening the fitting by means of a miniature wrench-like tool meshing with the flat portion of base 301. It is found in practice that hand-tightening the fitting of FIG. 3 typically results in a pressure-tight seal up to about 5,000 psi (pounds-per-square-inch), while tightening with a tool creates a pressure-tight seal up to about 10,000 psi. The fittings shown in FIGS. 2C and 2D seal up to at least about 40,000 psi when tightened with a tool.

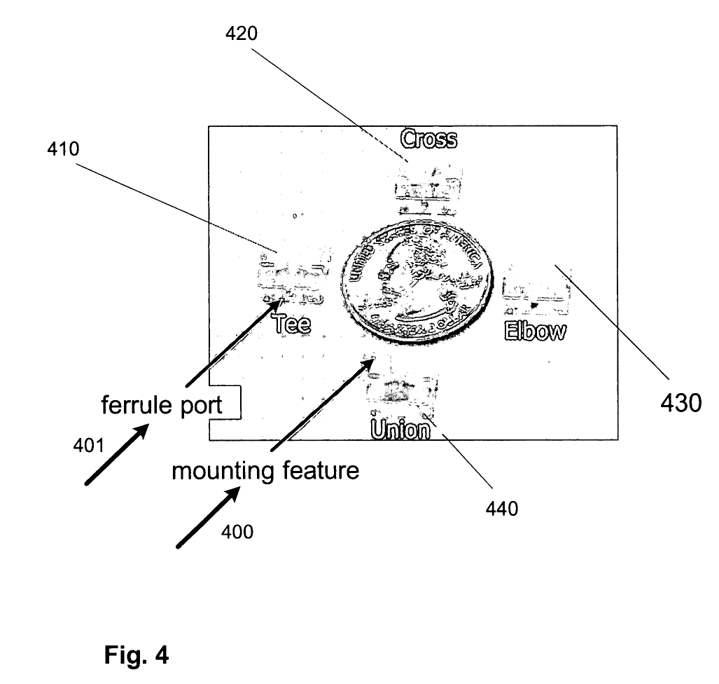

An important set of components in microfluidic systems includes devices for interconnecting capillaries and other devices, described herein as “interconnects.” FIG. 4 depicts a set of four such typical interconnects, depicted in comparison with a US 25 cent coin as having a size typically used in microfluidic systems. Typical dimensions for such interconnects are approximately 0.4 inches square by approximately (⅛) inch thick. Other dimension for interconnects can be used, but it is advantageous for the interconnects, as well as for other microfluidic components as described herein, to have a standard size facilitating rapid assembly of prototype systems.

Standard interconnects include the “Tee” 410, “Cross” 420, “Elbow” 430, and “Union” 440 providing four distinct interconnect topologies that, singly or in combination, are sufficient for almost all desired microfluidic devices. The four interconnects depicted in FIG. 4 provide a standard component set of interconnects that can be assembled into virtually any desired configuration to provide virtually any desired fluid-flow topology. However, special interconnects can readily be envisioned that have a different fluid-flow topology from any of the Tee, Cross, Elbow or Union interconnects. Such straight-forward modifications of the interconnects described herein are apparent to those having ordinary skills in the art and included within the scope of the present invention.

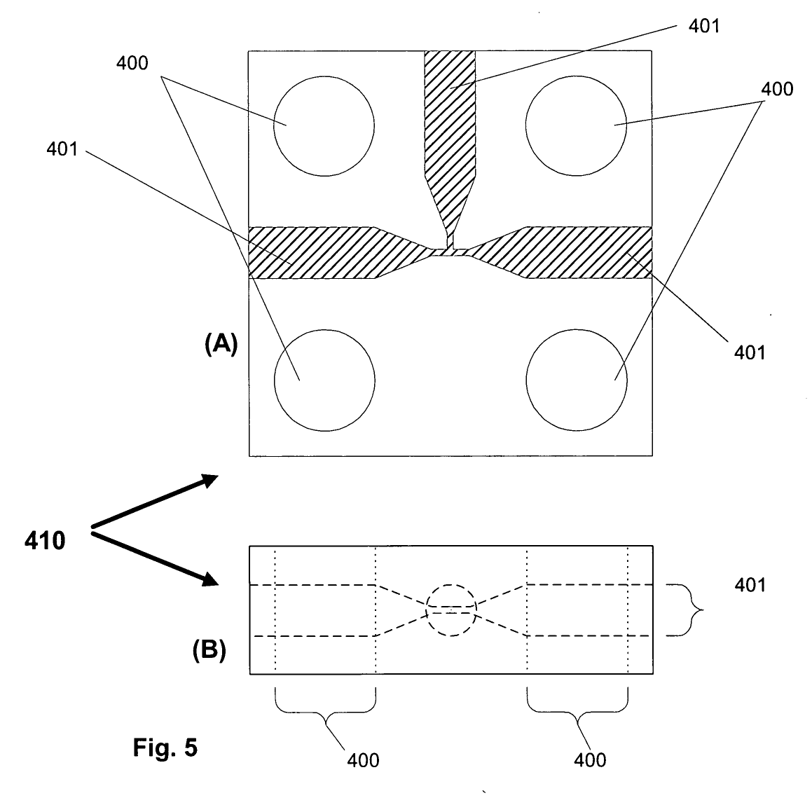

A more detailed depiction of the standard Tee interconnect pursuant to some embodiments of the present invention, 410, is given in FIG. 5A in top view and in FIG. 5B in side view. In typical operation of the interconnect, fluid is delivered to the interconnect through at least one port 401 and is extracted from the interconnect through at least one other port 401, typically through fittings as in FIG. 2A and capillaries 102. In some cases, fluid does not flow through the interconnect but a pressure is maintained without movement of fluid mass. However, interconnects are designed for the movement of fluid and, for simplicity of description, we will presume this occurs.

A typical interconnect 410 also contains mounting features 400 that are also denoted as “holes” or “openings”. It is advantageous that the mounting holes 400 be arranged in a square configuration with a standard hole size and distance between holes to facilitate rapid assembly of standard, interchangeable components. With this configuration of mounting holes, interconnect 410 (as well as other interconnects and components) can be joined in any of numerous orientations and locations for enhanced design and fabrication flexibility. Typically, it is found convenient in some embodiments of the present invention for the holes to have a diameter of about ( 1/16) inch, suitable for a “256 fastener” and a separation of about 0.25 inch between centers of adjacent holes.

Other embodiments of interconnects include a receiver (e.g., a tapped well or some other engaging receptacle) in any face of the interconnect into which a post with an amenable engaging feature (such as a dowel, gland, among others)can be engaged. The opposite end of the post engages with a hole of the prototyping platform, typically by threading. In this manner, only one hole of the prototyping platform needs to be used for each interconnect and mounting components about their central axis is facilitated. That is, since an amenable engaging feature can be a mating “cavity” in a component, it is less likely to disrupt and/or intercept a fluid- or signal-carrying channel within the component since it does not need to pass completely through the component.

Although associated dimensions for various configurations are rather arbitrary, they are advantageously chosen so the size of components and mounting devices are conveniently handled by human technicians, and the mounting holes are not so large as to seriously degrade the mechanical and other properties of the components. Relatively snug fits that provide a secure assembly while still enabling rotation of interconnects and components about the longitudinal axis of the fastener by which they are mounted are advantageous.

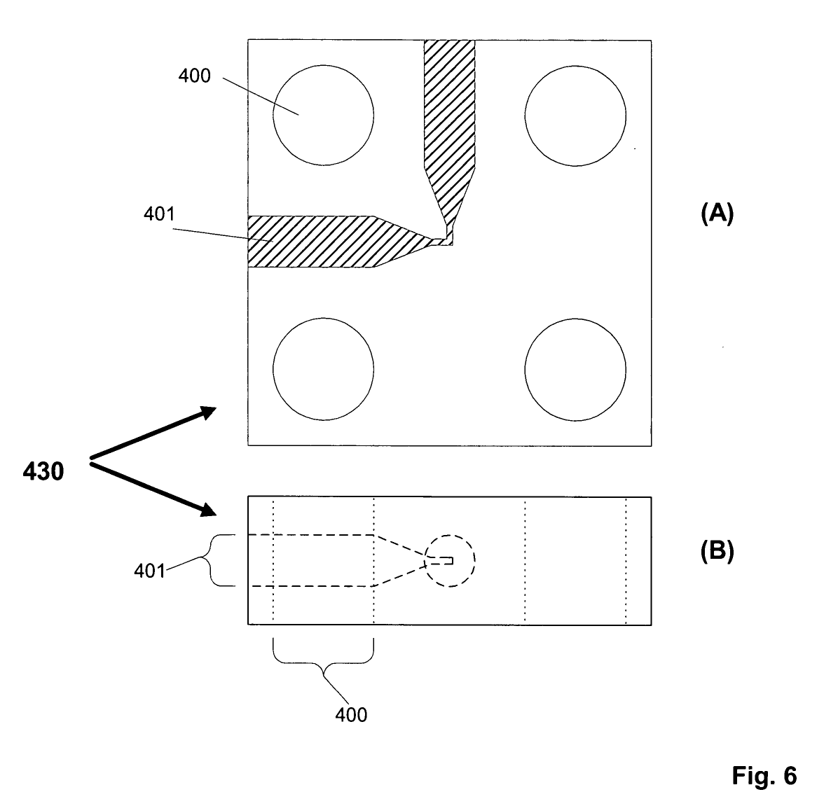

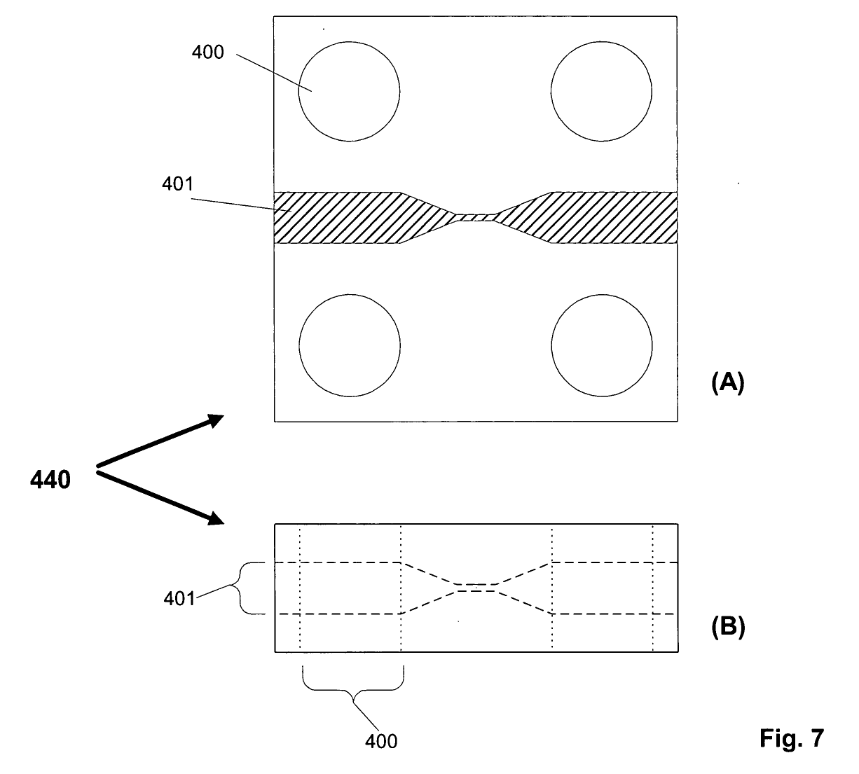

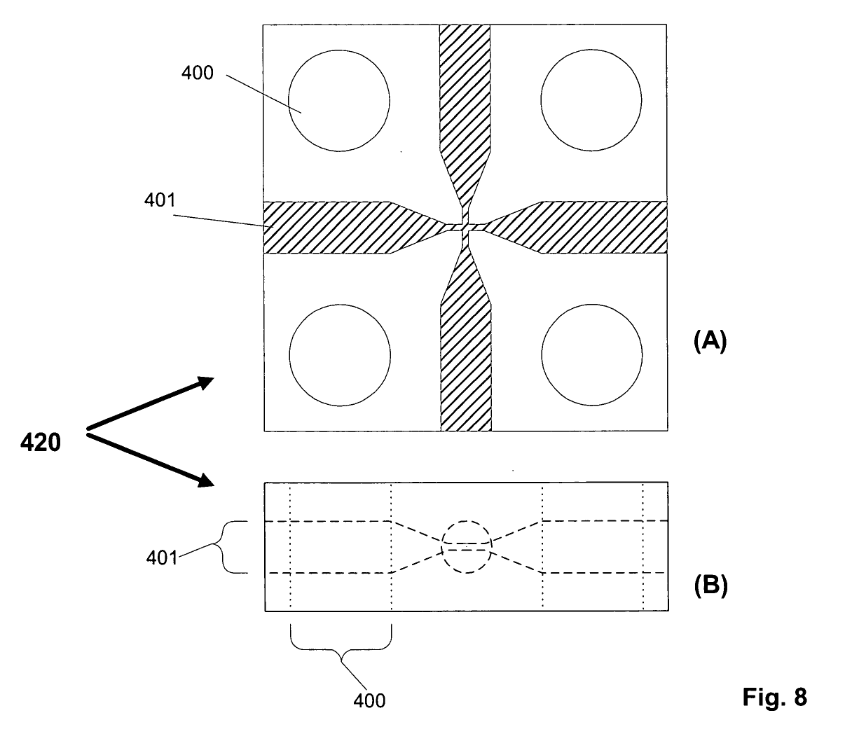

FIGS. 6A and 6B depict top and side views respectively of the Elbow interconnect 430. FIGS. 7A and 7B depict top and side views respectively of the Union interconnect 440. FIGS. 8A and 8B depict top and side views respectively of the Cross interconnect 420. In all cases, fluid (when flowing) is delivered into the interconnect by means of one or more of the ports 401 and extracted via one or more of the ports 401. Standard dimensions are advantageously used in all cases, typically those given above in connection with the Tee interconnect, 410.

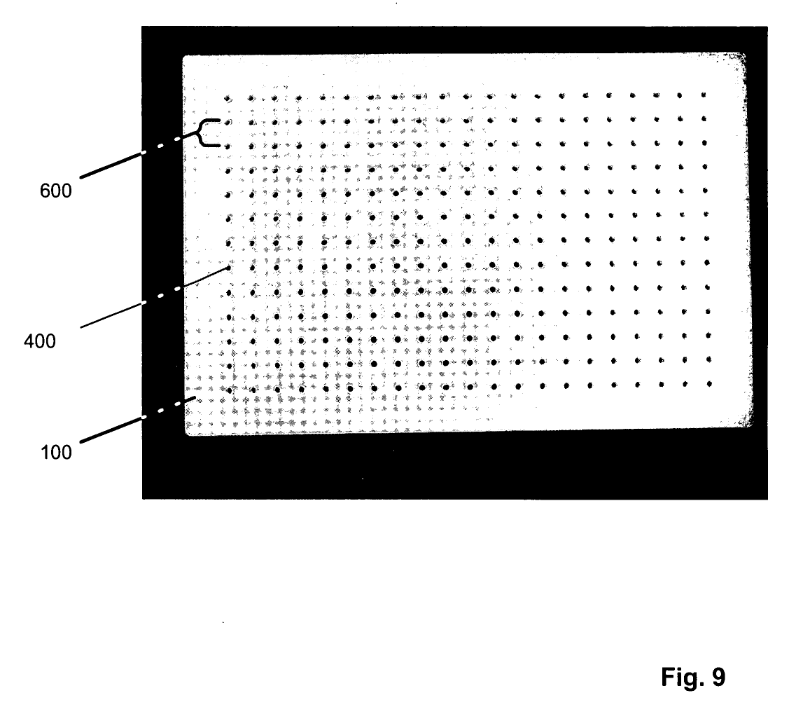

A typical prototyping platform pursuant to some embodiments of the present invention, 100, is depicted in FIG. 9. The holes or openings 400 advantageously have a square configuration to match those in the interconnects, that is, approximately ( 1/16) inch diameter holes spaced 0.25 inches center-to-center in a square configuration. Although square configurations are simple and advantageously employed in connection with some embodiments of the present invention, this is by way of illustration and not limitation. Other repeating patterns of holes can also be used with convenient symmetries for mounting various components.

The length and width of the prototyping platform, 100, can be any convenient size, typically rectangular or square in shape. As depicted in FIG. 1, various assemblies of microfluidic devices can employ multiple platforms. It is advantageous in some embodiments of the present invention for the prototyping platforms to be constructed with locking edges. For example a tongue-and-groove, snap-together configuration, or similar structure(s) performing a similar function placed around the periphery of the platform advantageously permits simple attachment and detachment of multiple platforms, but yet retain fixed relative positions when the platforms are joined at the periphery.

Platform 100 can be made out of any, or any combination of, materials chiefly determined by suitability for the application at hand. Biocompatibility, solvent compatibility, compatibility with lasers or other optical components, electrically insulating platforms, electrically conducting (typically grounded) platforms, are a few illustrative criteria by which the material and/or properties of the platform can be chosen. Also, different electrically conducting platforms can be used, electrically isolated from each other to permit different portions of a microfluidic device to be retained at different electrical potentials. Typical materials include aluminum, polyethylene, perfluoropolyethylene, printed circuit board materials, various plastics including the commercial products DELRIN, LEXAN, ULTEM, among others.

In selecting a suitable material out of which to manufacture the prototyping platform, manufacturability is also a consideration in addition to materials properties relevant to the particular microfluidic device to be supported. Various plastics and other materials can be machined by conventional or laser machining techniques, injection molded or by other techniques known in the art and consistent with the materials used and the desired costs of the materials and of the manufacturing process.

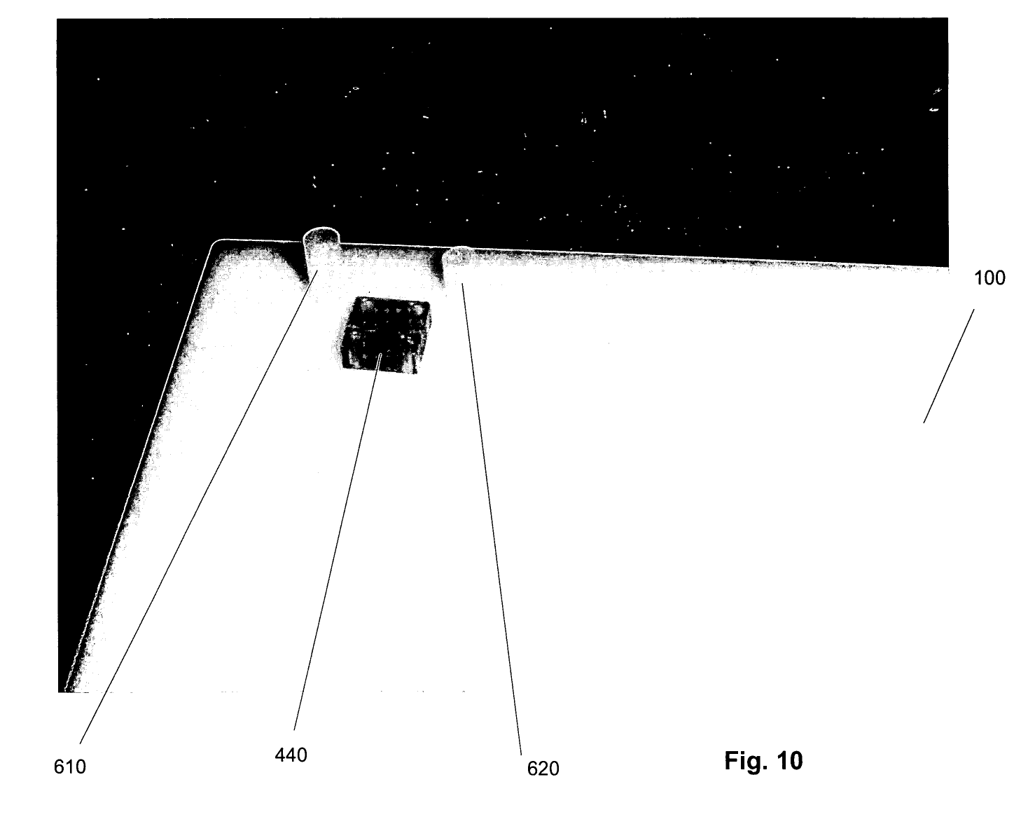

FIG. 10 depicts a typical prototyping platform, 100 with a typical interconnect 440 and two examples of typical spacers, 620 (approximately 0.25 inches in length) and 610 (approximately ⅜ inches in length). These are illustrative of typical microfluidic components that can be used in prototyping microfluidic devices pursuant to some embodiments of the present invention, and not meant to be limiting. Numerous other components and classes of components can also be utilized in connection with prototyping, some of which are depicted in FIG. 1 while others are conventionally and widely known in the field.

It is envisioned that components will typically be fastened to the prototyping platform through the various openings therein. A screw or bolt through the holes in the components and the platform will be advantageously employed as a fastening means in many cases. However, other fasteners in addition to screws and bolts can be employed, including but not limited to; strap and wire attachments, frictional fasteners, magnetic fasteners, compressive fasteners, cam lock fasteners, snap-fit fasteners among others. The end of the fastener that engages the prototyping platform, as well as the holes within the platform, can include attachment features compatible with those of the components. For example, a component can screw onto a post-type fastener which in turn screws into the platform. Additionally, the opposite ends of a fastener can be different. For example, one end can be threaded while the opposite end is a cam lock. Also, it can be advantageous in some embodiments to use adhesive as a fastening means. A curable adhesive can be employed (typically cured by heat, radiation, mixing reactive components in situ, among other curing mechanisms) forming a strong irreversible bond once cured. Other embodiments can use a releasable adhesive capable of forming and reforming many times for replacement, removal and/or repositioning of various microfluidic components. We refer to all such fastening means and devices as “fasteners” for economy of language.

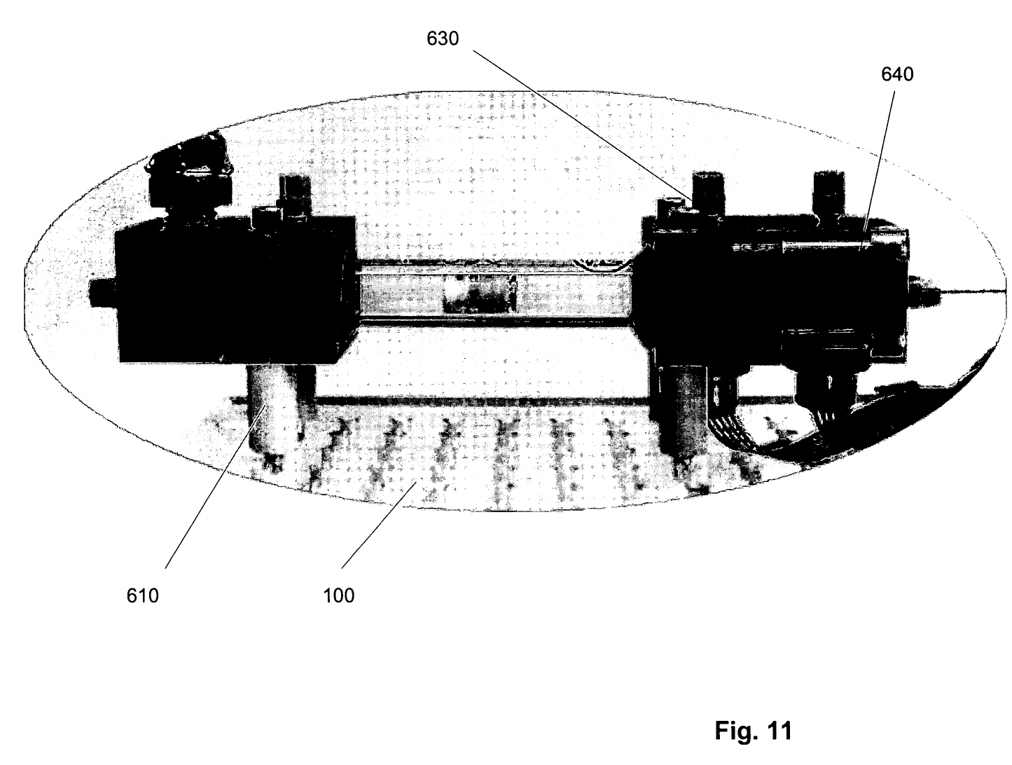

A typical microfluidic component attached to a prototyping platform 100 is depicted as 640 in FIG. 11, in particular an electrokinetic pump. The use of a screw fastener 630 and spacer 610 is clearly depicted. Multiple combinations of spacers 610, 620 and others can thus simply elevate microfluidic components to various heights (even one component on top of another) leading to rapid and effective prototyping of even complex microfluidic devices.

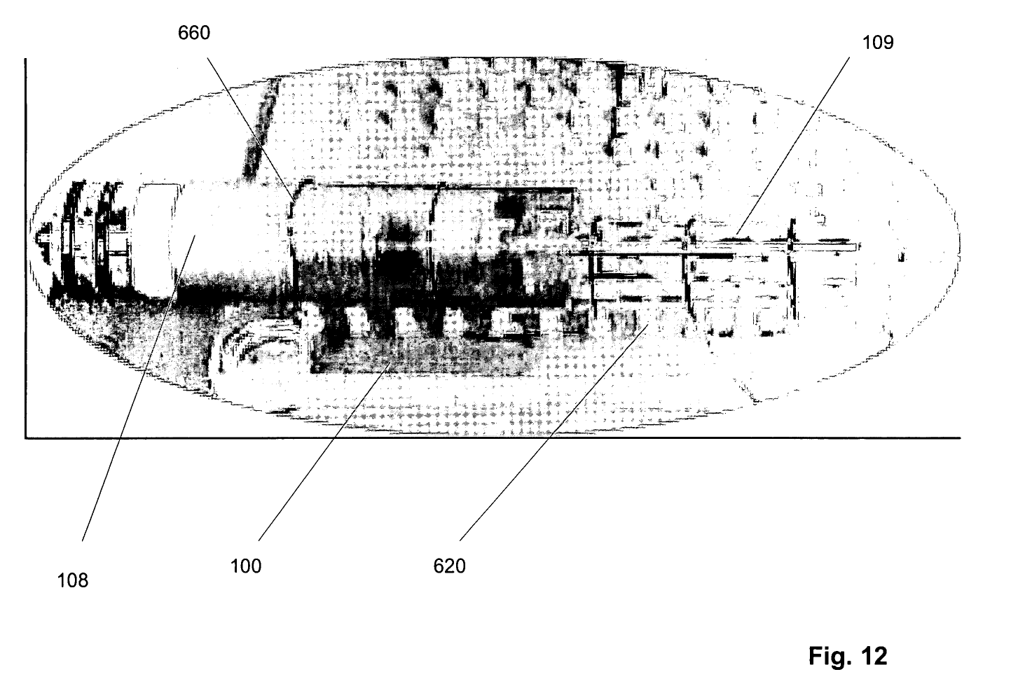

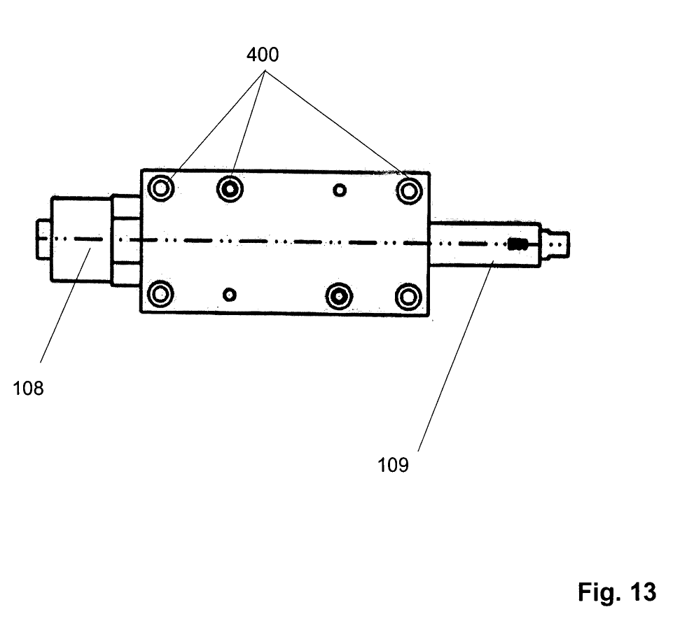

FIG. 12 is an enlarged view of the syringe 109 and syringe pump 108 from FIG. 1. An example of a wire or strap attachment is depicted 660 with spacers 620 providing elevation of the component above the prototyping platform 100. An alternative configuration of the syringe and syringe pump employing mounting holes 400 is depicted in FIG. 13.

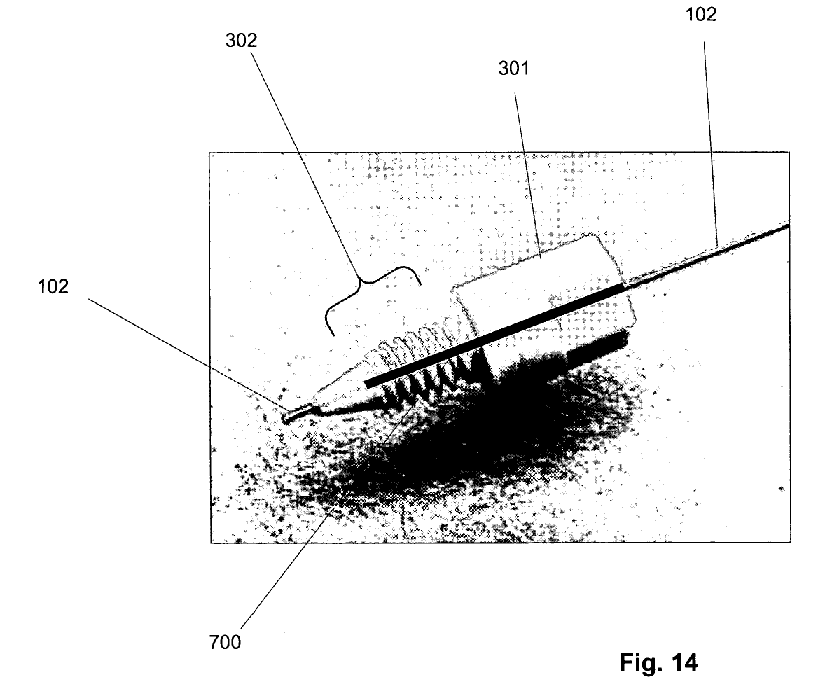

Important practical advantages of the prototyping platform and devices described herein include the ability to mount components loosely, allowing rotation or sliding of components prior to securely affixing such components to each other and to the platform. This feature is quite helpful when making connections between components that are very close together, since short lengths of capillary tubes are typically rigid and difficult to insert into connector bodies unless the connector bodies themselves are able to rotate or shift about their mounted positions. In this connection, a fitting having a slit as depicted in FIG. 14 is advantageous in that capillary insertion is facilitated. Variable height adjustments can also be made prior to firmly affixing components. This feature is also advantageous when making compact or user-friendly configurations or, for example, when attempting to avoid problems arising from hydrostatic heads (that is, flows induced by varying fluid heights). In addition, encapsulating procedures are greatly facilitated when components are configured in the same plane and, in this manner, height adjustment is facilitated.

Although various embodiments which incorporate the teachings of the present invention have been shown and described in detail herein, those skilled in the art can readily devise many other varied embodiments that still incorporate these teachings.

What is claimed is:

1. A microfluidic prototyping system comprising:
a) at least one microfluidic prototyping platform comprising a planar surface having a plurality of first openings therein, wherein said first openings have a repeating pattern, and wherein said first openings are suitable for receiving fasteners and thereby attach microfluidic components to said platform; and,
b) a plurality of microfluidic components having second openings therein complimentary to said first openings in said platform, wherein said second openings have a configuration so as to align with said first openings, and wherein said second openings are suitable for engaging fasteners and thereby attaching said components to said platform.

2. A microfluidic prototyping system as in claim 1 wherein at least one of said fasteners has a structure suitable for attaching said components to said platform while permitting positional adjustments of said components.

3. A microfluidic prototyping system as in claim 1 wherein at least one edge or surface of said at least one microfluidic prototyping platform has a structure capable of joining to an adjacent microfluidic prototyping platform.

4. A microfluidic prototyping system as in claim 1 wherein said at least one microfluidic prototyping platform comprises a plastic.

5. A microfluidic prototyping system as in claim 1 wherein said repeating pattern is substantially square.

6. A combination of microfluidic components comprising:
a) a microfluidic prototyping platform comprising a planar surface having a plurality of first openings therein, wherein said first openings have a repeating pattern; and,
b) at least one microfluidic interconnect wherein said at least one interconnect has openings therein in a configuration complimentary to said openings in said platform.

7. A combination as in claim 6 further comprising one or more microfluidic components and one or more fasteners, wherein at least one of said one or more fasteners has a structure suitable for attaching said components to said platform while permitting positional adjustments of said components.

8. A microfluidic interconnect comprising:
a) a path through the interior of said interconnect in a desired topology, wherein said path intersects the periphery of said interconnect in a fitting port; and,
b) a plurality of openings through said interconnect in a direction substantially perpendicular to the plane of said path, non-interfering with said path, and wherein said openings are suitable for passing fasteners therethrough.

9. A microfluidic interconnect as in claim 8 wherein said interconnect has openings therein having a complimentary configuration to openings in a microfluidic prototyping platform.

10. A combination of one or more microfluidic components and one or more fasteners, wherein at least one of said one or more fasteners has a structure suitable for attaching said components to each other or to a microfluidic prototyping platform while permitting positional adjustments of said components.

11. A kit for prototyping a microfluidic system comprising:
a) at least one prototyping platform as in claim 1; and,
b) a plurality of microfluidic devices having holes therein for attaching said devices to said at least one prototyping platform, including fasteners suitable for attaching said devices to said at least one prototyping platform; and,
c) a plurality of components selected from the group consisting of fittings, interconnects and capillaries, wherein said components are suitable for the delivery of fluid among said microfluidic devices.

12. A method of fabricating a microfluidic system comprising:
a) mounting a plurality of microfluidic components on a prototyping platform, wherein said mounting allows movement of one or more of said components about the mounting location of said one or more components; and,
b) securely interconnecting said components; and,
c) securing said components to said prototyping platform.

13. A method of fabricating a microfluidic system as in claim 12 further comprising encapsulating said prototyping platform and said components mounted thereon.

14. A method of fabricating a microfluidic system comprising establishing at least one path between microfluidic components wherein said establishing of said at least one path is facilitated by attaching said components to a microfluidic prototyping platform.

15. A microfluidic interconnect as in claim 8 further comprising an opening suitable for inserting a conduit therethrough without substantial bending of said conduit.

16. A microfluidic fitting including an opening suitable for inserting a conduit therethrough without substantial bending of said conduit.

17. A microfluidic prototyping system as in claim 1 further comprising at least one path between said microfluidic components.

18. A combination as in claim 10 further comprising interconnects forming paths between said components.
